(19) United States
(12) Patent Application Publication
(10) Pub. No.: US 2004/0117749 A1
(43) Pub. Date: Jun. 17, 2004

(54) System and method based on an object-oriented software design framework for displaying constrained graphical layouts

(75) Inventors: M. Kelly Lalonde, Toronto (CA); Jonathan D. Bennett, Markham (CA); Lok T. Loi, Toronto (CA)

Correspondence Address: Leslie A. Van Leeuwen, International Business Machines Corporation, Intellectual Property Law Department, 11400 Burnet Road, Austin, TX, 78758, US

(73) Assignee: INTERNATIONAL BUSINESS MACHINES CORPORATION, ARMONK, NY

(21) Appl. No.: 10/668,385

(22) Filed: Sep. 23, 2003

(30) Foreign Application Priority Data
Dec. 16, 2002 (CA) 2,414,472

(51) Int. Cl. G06F 9/455; G06F 17/50

(52) U.S. Cl. 716/11

(57) ABSTRACT

A system and method for use in the design of software applications in which constrained graphs are displayed, implemented in accordance with an object-oriented software design framework. According to one aspect of the invention, there is provided a software system comprising a first subgraph class that can be extended to define a plurality of second subgraph classes, where an instance of each second subgraph class represents a subgraph of a specific subgraph type, where each second subgraph class implements methods for repositioning the graphical elements of a subgraph represented by an instance thereof within the graph and determining affected subgraphs, displaying the graphical elements of a subgraph represented by an instance thereof to the user in a specified layout format, and commanding a repositioning and display of the graphical elements of the affected subgraphs. A first layout manager class that can be extended to define one or more second layout manager classes is also provided, where an instance of each second layout manager class represents a layout manager and implements methods for identifying the subgraphs in the graph, determining a selected subgraph to be repositioned, and commanding a repositioning and display of the graphical elements of the selected subgraph. The layout manager is thereby adapted to identify the subgraphs in a constrained graph, and to initiate the repositioning and display of the graphical elements of various subgraphs in the graph by commanding the repositioning and display of the graphical elements of the selected subgraph.

### FIELD OF THE INVENTION

The present invention relates generally to frameworks for use in the design of software applications, and more particularly to object-oriented frameworks for displaying constrained graphs.

### BACKGROUND OF THE INVENTION

Constrained graphs, also referred to herein as constrained graphical layouts, are graphs constructed using graphical elements that have been predefined in how they are composed and sequenced, which may be used to build complex graphical flows and which may be displayed in software applications. These graphical elements may include nodes, terminals, connections, and bundles of connections, for example. The graphical elements of a constrained graph are predefined in the sense that the composition of such graphical elements is determined at the time a particular software application is developed, and the rules that govern how such graphical elements may be sequenced together are also determined at that time. Put another way, the graphical elements of a constrained graph are restricted in the way that they may be ordered and laid out for display; the manner in which the graphical elements are so restricted is determined at development time.

Application-specific systems in which graphical elements of graphs are laid out for display exist in the prior art. For example, Canadian Patent Application No. 2,256,931 discloses a system and method that permits editing of source code to be performed in a graphical environment where a hierarchical model of the code structure of a project is displayed. As a further example, U.S. Pat. Nos. 6,301,686, 6,317,864, and 6,385,758, disclose features of a graphic layout system used to compact graphical layouts, as may be utilized in the design of layouts of large-scale semiconductor integrated circuits or printed-circuit boards.

However, from the perspective of a software developer or designer whose task is to design software applications in which constrained graphical layouts are to be displayed to users, there is a need for a means to facilitate the handling of the display of constrained graphical layouts and the updating of the constrained graphical layouts in response to user interactions. Such user interactions may include, for example, insertions of components or graphical elements to a constrained graphical layout, and deletions of components or graphical elements from a constrained graphical layout.

### SUMMARY OF THE INVENTION

The present invention is generally directed to an object-oriented software design framework for displaying constrained graphs.

According to a first aspect of the invention, there is provided a software system for constrained graphs, the system implemented in accordance with an object-oriented design framework, wherein said graph is constructed using a plurality of graphical elements, the system comprising: a plurality of subgraph classes, wherein an instance of each of said subgraph classes comprises a predefined grouping of one or more of said graphical elements representative of a subgraph type; and each of said plurality of subgraph classes adapted to: reposition the graphical elements of a subgraph within said graph, said subgraph represented by an instance of one of said plurality of subgraph classes; and initiate a repositioning of the graphical elements of subgraphs affected by said repositioning of the graphical elements of the subgraph represented by said instance of said one of said plurality of subgraph classes.

The software components of a software system for use in the design of software applications in which a constrained graph is displayed may be stored on computer-readable media.

According to another aspect of the invention, there is provided a software system for use in the design of software applications in which a constrained graph is displayed, the system implemented in accordance with an object-oriented design framework, wherein said graph is constructed using a plurality of graphical elements, the system comprising: a first subgraph class, wherein said first subgraph class can be extended to define a plurality of second subgraph classes, wherein an instance of each of said second subgraph classes represents a subgraph of a specific subgraph type, wherein each subgraph of a specific subgraph type is composed of a predefined grouping of one or more of said graphical elements, and wherein each of said plurality of second subgraph classes implements one or more first methods for: repositioning the graphical elements of a subgraph represented by an instance thereof within said graph and determining affected subgraphs, displaying the graphical elements of a subgraph represented by an instance thereof to said user in a specified layout format, and commanding a repositioning and display of the graphical elements of said affected subgraphs; and

The present invention relates to an object-oriented software design framework for the sequencing and display of graphical elements of constrained graphs. Conceptually, this framework requires that a constrained graph be broken down into smaller, manageable “pieces” to which layout rules are attached. The framework also requires that a controller be created to organize and manipulate these pieces. In accordance with the present invention, a system and method is provided that allows software developers to more easily extend this framework to support multiple display views, such that the display of components in alternate visual layouts (e.g., horizontal vs. vertical) and the ability to switch between these visual layouts are facilitated. The system and method also allow new pieces to be defined.

The framework upon which the present invention is based is scalable, allowing complex graphs to be handled in the same manner as less complex ones. The framework is also portable to different software applications and tools that may be used to build a variety of graphical flows. Furthermore, because the framework is object-oriented, it is easy for the software developer to maintain, understand, and customize. It allows the software developer to easily change the layout rules, and allows the various aspects of sequencing, displaying, and altering a constrained graph to be organized effectively.

In accordance with the present invention, the “pieces” into which a constrained graph is broken down are essentially smaller parts of the graph, and are referred to herein as subgraphs. Each subgraph is composed of a specific grouping of one or more graphical elements, as may be defined by the software developer at the time in which an application is being developed. These subgraphs are aware of themselves, in the sense that they have the ability to visually layout their graphical elements, and calculate their own properties (e.g. their height and width on a display, or their location on the display), for example. They also have the ability to shift themselves (i.e., move in a particular direction—e.g. horizontally, vertically, diagonally, etc.) on the display. This entails a repositioning of their graphical elements relative to those of other subgraphs in the graph. Under the object-oriented software design framework upon which the present invention is based, the classes used to define subgraphs can be extended (i.e. in the object-oriented programming sense) to support multiple display views without affecting the current design or implementation of a software application in development. The framework also allows new subgraphs to be easily defined during continued development, and existing subgraphs to be altered.

In order to determine, control, and keep track of these subgraphs, a controller, referred to herein as a layout manager, is provided in accordance with the present invention. The layout manager will analyze a constrained graph and map out subgraphs contained in the graph. The layout manager will then initiate the process of visually laying out the graphical elements of the graph for display, by first commanding a selected subgraph to reposition itself within the graph and then to redisplay its graphical elements. That selected subgraph will then determine which other subgraphs in the graph are affected by its repositioning, and in turn command those affected subgraphs to reposition and redisplay themselves accordingly. In this manner, changes in one portion of a graph being displayed are propagated to other portions of the graph, until the entire visual layout of the graphical elements of the graph is complete.

In a further aspect of the invention there is provided A computer readable media storing data and instructions, said data and instructions when executed by a computing device adapt said computing device to: organize a plurality of subgraph classes, wherein an instance of each of said subgraph classes comprises a predefined grouping of one or more of said graphical elements representative of a subgraph type; and each of said plurality of subgraph classes adapted to: reposition the graphical elements of a subgraph within said graph, said subgraph represented by an instance of one of said plurality of subgraph classes; and initiate a repositioning of the graphical elements of subgraphs affected by said repositioning of the graphical elements of the subgraph represented by said instance of said one of said plurality of subgraph classes.

In a still further aspect of the invention there is provided A layout manager defined by a layout manager interface, said layout manager interface provided by a software system for use in the design of software applications in which a constrained graph is displayed to a user, the system implemented in accordance with an object-oriented design framework, wherein said graph is constructed using a plurality of graphical elements, the system comprising: a first subgraph class, wherein said first subgraph class can be extended to define a plurality of second subgraph classes, wherein an instance of each of said second subgraph classes represents a subgraph of a specific subgraph type, wherein each subgraph of a specific subgraph type is composed of a predefined grouping of one or more of said graphical elements, and wherein each of said plurality of second subgraph classes implements one or more first methods for: repositioning the graphical elements of a subgraph represented by an instance thereof within said graph and determining affected subgraphs, displaying the graphical elements of a subgraph represented by an instance thereof to said user in a specified layout format, and commanding a repositioning and display of the graphical elements of said affected subgraphs; and a first layout manager class interface, wherein said first layout manager class can be extended to define one or more second layout manager classes, wherein an instance of each of said second layout manager classes represents a layout manager, wherein each of said second layout manager classes implements one or more second methods for identifying a plurality of subgraphs in said graph, receiving an identifier of an input subgraph in said graph, determining from said identifier a selected subgraph to be shifted, and commanding a repositioning and display of the graphical elements of said selected subgraph by calling the one or more first methods implemented by the second subgraph class of which said selected subgraph is an instance; such that when an instance of a second layout manager class is created, said one or more second methods are executed, whereby layout manager represented by that instance identifies a plurality of subgraphs in said graph and initiates the repositioning and display of the graphical elements of a plurality of subgraphs in said graph by commanding the repositioning and display of the graphical elements of a selected subgraph in said graph.

In a still further aspect of the invention there is provided a method of displaying a constrained graph, said graph constructed using a plurality of graphical elements, wherein a first subgraph class is defined that can be extended to define a plurality of second subgraph classes, wherein an instance of each of said second subgraph classes represents a subgraph of a specific subgraph type, wherein each subgraph of a specific subgraph type is composed of a predefined grouping of one or more of said graphical elements, and wherein each of said plurality of second subgraph classes implements one or more first methods for repositioning the graphical elements of a subgraph represented by an instance thereof within said graph and determining affected subgraphs, displaying the graphical elements of a subgraph represented by an instance thereof to said user in a specified layout format, and commanding a repositioning and display of the graphical elements of said affected subgraphs, said method comprising: identifying a plurality of subgraphs in said graph; receiving an identifier of an input subgraph in said graph; determining from said identifier a selected subgraph to be shifted; and commanding a repositioning and display of the graphical elements of said selected subgraph by calling the one or more first methods implemented by the second subgraph class of which said selected subgraph is an instance; whereby a plurality of subgraphs in said graph are identified, and the repositioning and display of the graphical elements of a plurality of subgraphs in said graph is initiated by commanding the repositioning and display of the graphical elements of a selected subgraph in said graph.

In a still further aspect of the invention there is provided a method of displaying a constrained graph, said graph comprising a plurality of graphical elements and a plurality of subgraphs, wherein each of said plurality of subgraphs comprises a grouping of one or more of said graphical elements, said method comprising: determining from an identifier of an input subgraph in said graph, a selected subgraph to be repositioned; and repositioning the graphical elements of said selected subgraph.

In a still further aspect of the invention there is provided a method of displaying a constrained graph, said graph comprising a plurality of graphical elements and a plurality of subgraphs, wherein each of said plurality of subgraphs comprises a grouping of one or more of said graphical elements, said method comprising: repositioning the graphical elements of a subgraph within said graph; and initiate a repositioning of the graphical elements of subgraphs affected by said repositioning of the graphical elements of said subgraph.

### BRIEF DESCRIPTION OF THE DRAWINGS

For a better understanding of the present invention, and to show more clearly how it may be carried into effect, reference will now be made, by way of example, to the accompanying drawings which show preferred and variant embodiments of the present invention, and in which:

FIG. 1 is a schematic diagram of a computing system in which resides a software application developed in accordance with an embodiment of the present invention;

FIG. 2 is a class diagram illustrating an example implementation of the software components used in a software application designed in accordance with an embodiment of the present invention;

FIG. 3A is a flowchart illustrating the steps performed by a layout manager in a method of displaying a constrained graph in an embodiment of the present invention;

FIG. 3B is a flowchart illustrating the steps of a method of creating a hash map of subgraphs in an embodiment of the present invention;

FIG. 3C is a flowchart illustrating the steps of a method of shifting and redoing the layout of subgraphs in an embodiment of the present invention;

FIG. 4 is an example of a graph displayed in an editor developed in accordance with an example implementation of an embodiment of the present invention; and

FIGS. 5 through 8 are further examples of graphs displayed in an editor developed in accordance with an example implementation of an embodiment of the present invention.

### DETAILED DESCRIPTION OF THE PREFERRED EMBODIMENTS

The present invention relates to an object-oriented software design framework for the sequencing and display of graphical elements of constrained graphs. More particularly, the present invention provides a design framework that can be followed and extended by a software developer to display constrained graphs in a software application. The terms “developer” and “designer” may be used interchangeably in the description and in the claims, and the use of any particular term is not intended to limit the scope of the present invention. Similarly, actions derived from the terms “design”, “develop”, and “program” where used in the description and in the claims may be used interchangeably, and the use of any particular term is not intended to limit the scope of the present invention. While a software developer will define specific algorithms to generate a visual layout of graphical elements of a constrained graph for display in the development of a software application, the invention provides a generic framework that may be used to aid in the development. The framework is based on a design methodology in which a graph is divided into subgraphs, where the subgraphs are aware of themselves and can find other subgraphs, where the subgraphs are adapted to control the shifting of their own graphical elements within the graph, and where the subgraphs are adapted to control the display of their own graphical elements. The concept of a subgraph is explained in further detail below.

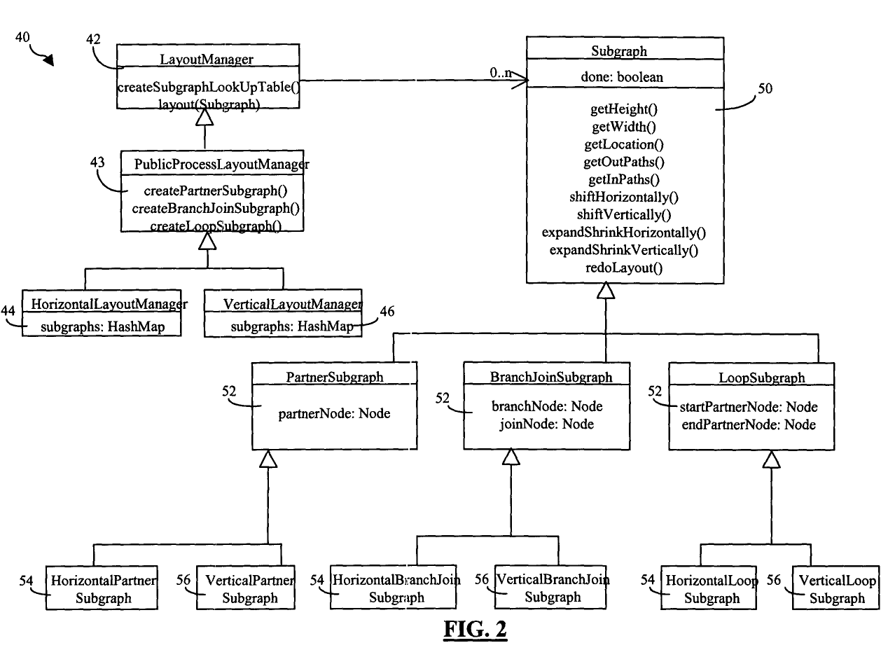

Constrained graphs are graphs constructed using graphical elements that have been predefined in how they are composed and sequenced, which may be used to build complex graphical flows and which may be displayed in software applications. Graphical flows can be used in the modeling of various processes, for example. In a layout of the graphical elements of a constrained graph, there are certain rules, defined at development time, which the layout must conform to. Accordingly, the term “constrained” is used in reference to the graphical elements available in building the graph and to the rules on how these graphical elements may be combined; the term is not being used to suggest that the graph is, in some way, “static”. On the contrary, the present invention provides means to dynamically manage an expanding and contracting graph in response to user interactions such as insertions and deletions of graphical elements in the graph. To make a large, complex, constrained graph more manageable, in accordance with the present invention, the constrained graph is broken down into smaller parts, referred to herein as subgraphs. Each subgraph, being part of the larger graph, is also composed of one or more graphical elements (e.g. nodes, terminals, connections, bundles of connections, other subgraphs). However, a subgraph is not merely an arbitrary collection of graphical elements. Each type of subgraph is characterized by a specific grouping or combination of graphical elements, which is defined by the software developer. Generally, the different types of subgraphs into which a graph may be broken down are defined by the software developer at the time in which an application is being developed. However, once an initial set of different subgraph types is defined, other types of subgraphs may be defined later in the development process, as will be apparent to persons skilled in the art from the description provided below, and particularly with reference to FIG. 2.

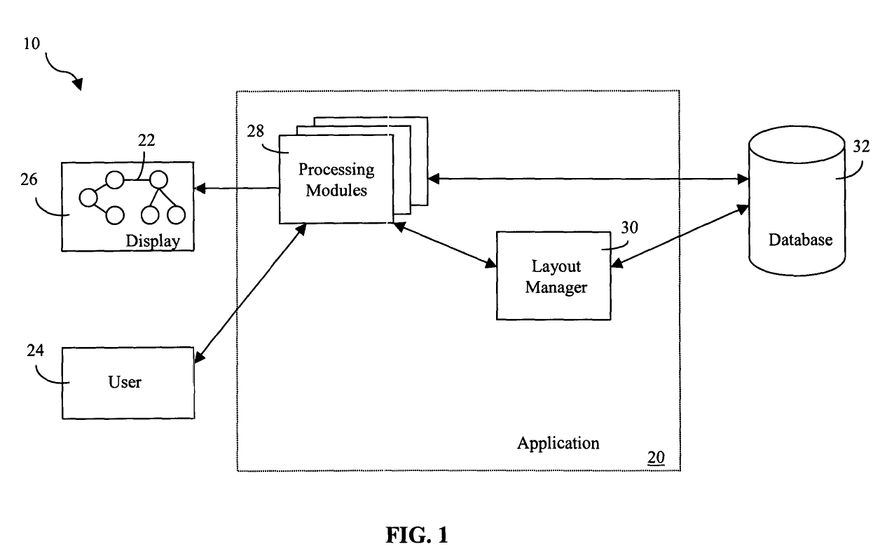

Referring to FIG. 1, a schematic diagram of a computing system in which resides a software application developed in accordance with an embodiment of the present invention is shown generally as 10.

Computing system 10 comprises a software application 20 designed by a software developer in accordance with an embodiment of the present invention, and which resides on a computing device [not shown]. In the execution of application 20, a visual layout of graphical elements of a constrained graph 22 is generated for display to a user 24 in a display screen 26. It will be understood by persons skilled in the art, that constrained graph 22 may be displayed on other known display devices.

In designing application 20, one or more processing modules 28 were programmed to display constrained graph 22 (i.e. to generate the visual layout of graphical elements of constrained graph 22). During the execution of application 20, user 24 may perform tasks that require processing modules 28 to alter the display of constrained graph 22. For example, user 24 may perform tasks that require processing module 28 to insert one or more graphical elements to and/or delete one or more graphical elements from constrained graph 22. When graphical elements are to be added or deleted, the display of constrained graph 22 must be refreshed on display screen 26 to reflect those changes. In accordance with the present invention, application 20 is designed in such a manner as to facilitate the refreshing of the display on display screen 26 in response to additions or deletions as initiated by the user. In preferred embodiments of the invention, a layout manager 30 is created upon the addition or deletion of graphical elements that require the display of constrained graph 22 to be refreshed, as described in greater detail with reference to FIG. 2.

Processing modules 28 and layout manager 30 may store data in and retrieve data from a database 32. It will be appreciated by those skilled in the art that application 20 and database 32 need not reside on the same computing device. It will also be appreciated by those skilled in the art that data in database 32 may instead be stored in a memory or other storage device, and that data in database 32 may be distributed across multiple storage devices and/or memories.

Application 20 may also be referred to as a modeling tool depending on how it is used, and particularly where application 20 is used primarily to build and manipulate constrained graphs 22 for the purpose of modeling processes using graphical flows. In these implementations, user 24 may be permitted to input requests for the addition and/or deletion of graphical elements of constrained graph 22 to processing modules 28 directly.

Referring to FIG. 2, a class diagram illustrating an example implementation of the software components used in a software application designed in accordance with an embodiment of the present invention is provided, and shown generally as 40. The software components are part of a software system that can be used in the development of software applications, and are implemented in accordance with an object-oriented design framework. In accordance with this framework, there is provided two base classes in this embodiment of the invention defined for subsequent implementation, one for defining a layout manager and the other for defining subgraphs, as described herein.

Software system 40 comprises a layout manager interface 42, which is a base class used to define a layout manager. Layout manager interface 42 is extended by classes specific to the use of the layout manager in a particular implementation (e.g. Public Process Layout Manager class 43 in this example), which can be further extended by classes corresponding to the different types of display views offered, such as a HorizontalLayoutManager class 44 and a VerticalLayoutManager class 46 to display subgraphs in a horizontal layout and a vertical layout respectively in this example implementation. In this example, as shown in FIG. 2, layout manager interface 42 has two methods that must be implemented: createSubgraphLookUpTable( ) for creating and finding subgraphs in a constrained graph (e.g. constrained graph 22 of FIG. 1) to be stored in a lookup table (e.g. hash map), and layout(Subgraph) for initiating the layout of the graph at the identified subgraph. These methods are implemented by classes that extend layout manager interface 42.

An instance of a layout manager class (i.e. a layout manager, e.g. layout manager 30 of FIG. 1) would be created each time the display of the constrained graph is altered. Where different types of layout managers are supported (e.g. instances of HorizontalLayoutManager class 44 and VerticalLayoutManager class 46), a developer using software system 40 may define a switch or flag to determine the type of layout manager to be created upon the occurrence of a specific event. A layout manager is created in response to a user input to add or delete one or more graphical elements in the constrained graph, for example. In adding or deleting components, the application user is not aware of how subgraphs are defined. Preferably, in implementations of the present invention, a user interface is utilized and designed to ensure that when a user modifies the constrained graph, that it is done in such a manner that the constrained graph is kept in a valid state, in that it can be broken down into subgraphs without any excess graphical elements left over.

After a layout manager is created, the constrained graph, as it exists after it is altered, is then grouped into subgraphs. Subgraphs of a constrained graph consist of specific, smaller groupings of graphical elements. Subgraphs may consist of a grouping of nodes and connections forming a single unit, or a more complex collection of groups of subgraphs that are connected, for example. The different types of subgraphs that a constrained graph can be broken down into is determined at the time a software application (e.g. application 20 of FIG. 1) is developed. In the preferred embodiment of the invention, this is facilitated by the definition of an abstract subgraph class 50 in software system 40.

Abstract subgraph class 50 includes a number of methods to be implemented, which may be used to determine various properties of a given subgraph. These may include methods to determine the position of a subgraph (e.g. as indicated by the position of the top-left corner of the subgraph in the displayed constrained graph, by the coordinates of the upper-leftmost node), the dimensions of a subgraph (e.g. the height and width the subgraph takes up on the screen), and the connections or paths going in and out of a subgraph. Abstract subgraph class 50 also requires that a number of methods be implemented in classes that extend it to perform various functions. For example, these methods are used to shift a subgraph (i.e. to shift the graphical elements of the subgraph) in various directions (e.g. horizontally, vertically, diagonally, etc.), and to redo or redisplay the layout of connections and nodes of the subgraph so that they do not overlap with those of other subgraphs. When a subgraph shifts, it is shifting its graphical elements with respect to the graphical elements of other subgraphs in the view. When a particular subgraph redoes its layout, it arranges its own graphical elements with respect to each other in the space where the particular subgraph is to be displayed.

Abstract subgraph class 50 is extended by more specific subgraph classes 52 that represent each type of subgraph. These classes would not only inherit the properties of its parent abstract subgraph class 50, but it can also contains more specific properties such as the associated nodes and/or connections that make up the respective types of subgraphs represented by the specific subgraph classes 52. In preferred embodiments of the invention, specific subgraph classes 52 would also implement the shifting methods of abstract subgraph class 50. These specific subgraph classes 52 can be further extended by more specific subgraph classes 54, 56 corresponding to the different display view types to be offered. These more specific subgraph classes 54, 56 would specifically implement how the subgraphs that their instances represent will redo their layout, depending on the orientation associated with the corresponding display view.

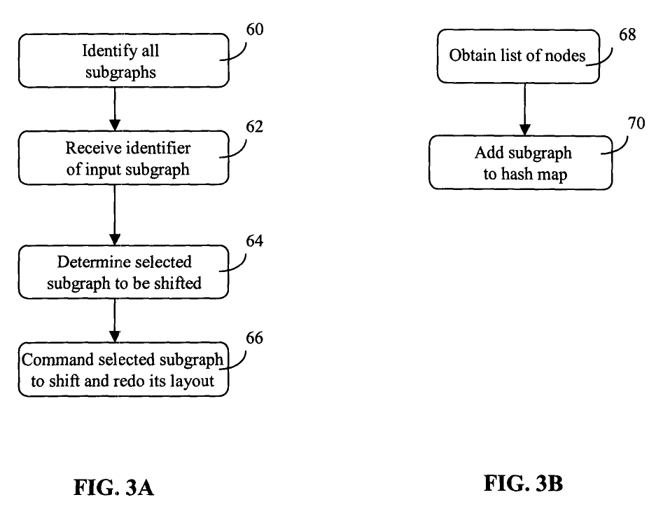

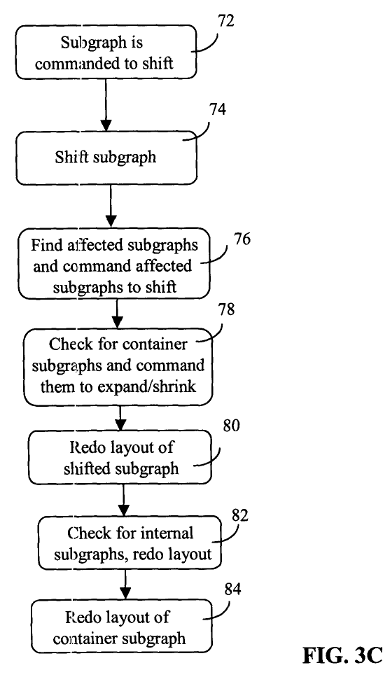

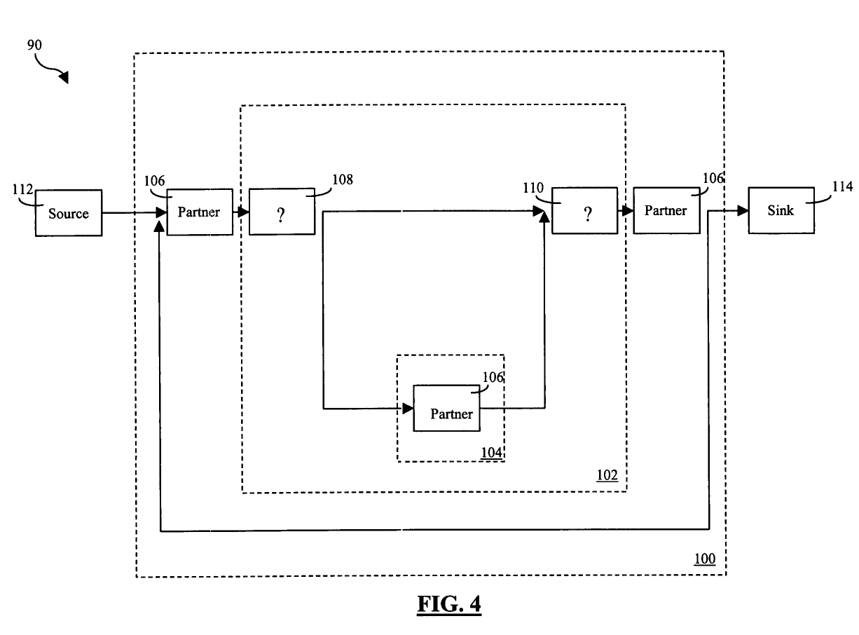

In grouping a constrained graph into subgraphs, the layout manager creates a hash map of subgraphs upon analyzing the constrained graph to provide a map to the subgraphs found. In this embodiment of the invention, the hash map uses the upper-leftmost node of a subgraph as a key to map to the corresponding subgraph, although other keys can be defined for a subgraph. In variant embodiments of the invention, more complex keys can be created to avoid conflicts, as desired by the developer. Further, while a hash map is used in preferred embodiments of the invention, in variant embodiments of the invention, different data structures or lookup tables (i.e. maps) may be used to map and identify the subgraphs. Other information could also be stored in the data structure used, as desired by the developer. For example, references to container subgraphs and internal subgraphs (as described with reference to FIG. 3C) could be stored.

A “done” flag may also be defined in abstract subgraph class 50. Upon creation of the hash map of subgraphs, every subgraph's done flag is set to “false”. When a subgraph redoes its layout, the done flag is set to “true”. The flag is used to prevent infinite cycles between nested subgraphs being called to redo their layouts. This is due to the fact that a subgraph may not be aware of where a call to redo its layout originates. The use of this flag prevents subgraphs from redoing their layouts in situations where this task was already previously completed and need not be performed again. In variant embodiments of the invention, other mechanisms may be used to prevent infinite cycles of calls to redo the layouts of subgraphs.

After all the subgraphs in the constrained graph are identified and mapped using the hash map, starting with a selected subgraph, the layout manager will command the selected subgraph to either shift away from a particular reference point or source (e.g. the leftmost node in the constrained graph) to accommodate an addition of one or more graphical elements, or to shift towards a particular reference point or source to accommodate the deletion of one or more graphical elements. The reference point is used to determine where the layout manager should begin the visual layout of the graphical elements of subgraphs, and can be defined by the developer. The layout manager will then call the selected subgraph to redo its layout, a process in which nodes and connection bend points in the selected subgraph are repositioned and redrawn to accommodate changes in the constrained graph.

Put another way, the layout manager is adapted to pick a starting point for the shifting of subgraphs and the graphical elements thereof, and to determine the first subgraph (i.e. the selected subgraph) that needs to shift and display its graphical elements. This initiates, in the appropriate direction, the process of shifting other affected subgraphs and displaying the graphical elements of those other affected subgraphs in the constrained graph. Affected subgraphs are subgraphs that must be shifted and/or redisplayed to ensure that the graphical elements of the constrained graph do not overlap with one another, which might result during the shifting of subgraphs (and the graphical elements thereof) within the constrained graph. This determination can be facilitated by accessing the information on the subgraphs of the constrained graph, located using the hash map. In the example implementation described with reference to FIG. 2, abstract subgraph class 50 defines a method for determining the paths leading out of a subgraph (i.e. getOutPaths( )) which is implemented by the more specific subgraph classes (e.g. specific subgraph classes 52) extending abstract subgraph class 50. To find affected subgraphs, these paths leading out of a given subgraph (in the direction that subgraphs are being shifted) can be traversed until a node is reached which represents a key to an adjacent subgraph is found. It is assumed that the adjacent subgraph overlaps with the given subgraph, and the former will be commanded to shift and redo its layout, which in turn will require other subgraphs to shift as well. Subgraphs are adapted to communicate with each other, such that when any subgraph shifts and displays its layout, that subgraph is able to determine which other subgraphs are affected by the shift, and can command them to shift themselves and display their own layouts. In this manner, changes to the constrained graph will propagate through the entire constrained graph. Other algorithms may be implemented to determine affected subgraphs in variant embodiments of the invention, and any specific implementation may depend on the structure of the various subgraphs initially defined by the developer.

More than one instance of different types of layout managers can be associated with a constrained graph to display the constrained graph in various views. Instances of HorizontalLayoutManager class 44 and VerticalLayoutManager class 46 are adapted to display a layout of the graphical components of subgraphs from left to right and top to bottom respectively. However, in variant embodiments of the invention, other types of layout managers may be used (e.g. ones that facilitate a right-to-left horizontal layout, a bottom-to-top vertical layout of subgraphs within the constrained graph, etc.).

The software components of a software system 40 may be stored on computer-readable media.

Referring to FIG. 3A, a flowchart illustrating the steps performed by a layout manager in a method of displaying a constrained graph in an embodiment of the present invention is shown.

At step 60, the layout manager (e.g. layout manager 30 of FIG. 1) identifies all subgraphs in the constrained graph. In the example implementation described with reference to FIG. 2, this step is performed by the createSubgraphLookUpTable( ) method, which is defined in layout manager interface 42 (FIG. 2) and which is implemented in classes that extend layout manager interface 42. Each subgraph is of a type of subgraph that has been defined by the developer, and accordingly a specific subgraph class is defined for each subgraph that is to be identified in the constrained graph. This can be done by programming a method to determine the “type” of each node in the constrained graph and to look at other graphical elements, such as surrounding connections and nodes to determine the type of subgraph that corresponds to that node. It is up to the developer to determine how a certain subgraph is to be detected, since the developer had defined what the subgraphs are. A key and the corresponding subgraph instance identified at this step are stored in a hash map in preferred embodiments of the invention, as discussed further with reference to FIG. 3B. As noted above, in variant embodiments of the invention, different data structures or lookup tables may be used to map and identify the subgraphs.

At step 62, an identifier of an input subgraph is received, and at step 64, a selected subgraph to be shifted is determined from the identifier. As explained with reference to FIG. 2, the selected subgraph is the first subgraph which the layout manager will initially shift, and which ultimately causes other affected subgraphs in the constrained graph to shift. Typically, the input subgraph will be the same as the selected subgraph, in which case the identifier identifies the specific selected subgraph to be shifted. In the example implementation described with reference to FIGS. 4 through 8, the determination of the selected subgraph to be shifted at step 64 identified by the identifier received at step 62 is initially performed by the application (e.g. a public process tool) that creates a directional layout manager (e.g. an instance of HorizontalLayoutManager class 44 or VerticalLayoutManager class 46 of FIG. 2).

At step 66, the layout manager commands a shifting of the selected subgraph (i.e. a repositioning of the graphical elements of the selected subgraph) and a redoing of the layout (i.e. a displaying) of the graphical elements of the selected subgraph by calling the appropriate methods of the specific subgraph class of which the selected subgraph is an instance. In the example implementation described with reference to FIG. 2, this step is performed by the layout(Subgraph) method, which is defined in layout manager interface 42 (FIG. 2) and which is implemented in classes that extend layout manager interface 42. Examples of methods for shifting subgraphs and redoing the layout of graphical elements of subgraphs in an embodiment of the present invention are described in greater detail with reference to FIG. 3C.

Referring to FIG. 3B, a flowchart illustrating the steps of a method of creating a hash map of subgraphs in an embodiment of the present invention is shown, as may be performed at step 60 of FIG. 3A. In the example implementation described with reference to FIG. 2, the steps described in FIG. 3B are performed by the createSubgraphLookUpTable( ) method, which is defined in layout manager interface 42 (FIG. 2) and which is implemented in classes that extend layout manager interface 42.

At step 68, a list of all nodes in the constrained graph is obtained.

At step 70, for each node in the list obtained at step 68, if the node corresponds to a type of subgraph, the subgraph is added to a hash map using that node as the key. As indicated above with reference to FIG. 3A, this can be done by determining the “type” of each node in the constrained graph, and looking at other graphical elements such as surrounding nodes and connections to determine the type of subgraph that corresponds to that node. The details of the specific algorithm or method used to implement this step will depend on the key that is chosen to look up subgraphs in the hash map.

For example, if the upper-left most node of a subgraph is used as a key, since any given subgraph can be identified by a specific combination and organization of nodes and connections with a node in its upper-leftmost position, that node can be considered to “correspond” to the given subgraph. However, if a particular node in the list cannot be considered to be an upper-leftmost of a given subgraph, but is merely an intermediate element of the subgraph, that node would not be considered to “correspond” to a type of subgraph in performing this step, and that node would not be added to the hash map as a key to the given subgraph.

Referring to FIG. 3C, a flowchart illustrating the steps of a method of shifting and redoing the layout of subgraphs in an embodiment of the present invention is shown, as may be performed at step 66 of FIG. 3A.

At step 72, a subgraph is commanded to shift; that is, to reposition its graphical elements. For example, a layout manager will command a selected subgraph to shift in order to “kick-off” the process of the shifting of subgraphs within the constrained graph.

At step 74, the subgraph commanded to shift at step 72 is shifted. The manner in which a subgraph is shifted will depend on the type of subgraph and its characteristics as defined by the developer, and therefore an appropriate algorithm for shifting a given subgraph is to be defined by the developer. In shifting, the subgraph must shift its graphical elements; the manner in which the subgraph is shifted will be specific to that type of subgraph.

At step 76, the subgraph shifted at step 74 will find any subgraphs affected by the shift. In implementations of the present invention where subgraphs are to be shifted in a single, linear direction, subgraphs that are “directly following” the shifted subgraph will be found at this step. The affected subgraphs will be told to shift, starting a chain reaction of subgraphs commanding subgraphs directly following them to shift until the end of the constrained graph is reached. In this embodiment of the invention, a method is defined in each specific subgraph class that is used to find any subgraphs that directly follow the shifted subgraph. The manner in which the “directly following” subgraphs are found will depend on how the shifted subgraph connects to other subgraphs in the constrained graph, the position of the reference point to and from which graphical elements of the subgraph are shifted, and the general direction in which the shifting of subgraph is to occur, which typically depends on the orientation of the various subgraphs in the constrained graph and the manner in which they are laid out. Affected subgraphs may also include internal subgraphs within the subgraph shifted at step 74. If the subgraph being shifted contains any internal subgraphs (i.e. subgraphs within the given subgraph) that must be shifted to prevent an overlap of graphical elements, the graphical elements of those internal subgraphs must also be shifted accordingly at this step. In the example implementation described with reference to FIG. 2, steps 72, 74 and 76 are performed by either the shiftHorizontally( ) or shiftVertically( ) methods, which are defined in abstract subgraph class 50 (FIG. 2) and which are implemented in classes that extend abstract subgraph class 50. Other methods that return properties on a given subgraph such as getHeight( ), getwidth( ), getLocation( ), getOutPaths( ), and getInPaths( ) may also be used by the shiftHorizontally( ) or shiftVertically( ) methods as required, in this example implementation. As will be appreciated, alternative methods could be implemented. For example, a shiftDiagonally( ) method could be implemented that could enable a subgraph to be shifted diagonally rather than having two separate methods: a horizontal and a vertical method to shift in the appropriate directions.

At step 78, any container subgraphs (i.e. subgraphs in which the given subgraph is contained, also referred to as “parent” subgraphs) are checked for. If a container subgraph exists, the container subgraph is expanded or contracted (i.e. shrunk) so that the container subgraph can accommodate changes in the constrained graph where necessary. In some cases, the expansion or contraction of a subgraph will require other subgraphs directly following it to be shifted. In the example implementation described with reference to FIG. 2, this step is performed by either the expandShrinkHorizontally( ) or expandShrinkVertically( ) methods, which are defined in abstract subgraph class 50 (FIG. 2) and which are implemented in classes that extend abstract subgraph class 50. Other methods that return properties on a given subgraph such as getHeight( ), getwidth( ), getLocation( ), getOutPaths( ), and getInPaths( ) may also be used by the expandShrinkHorizontally( ) or expandShrinkVertically( ) methods as required, in this example implementation. It will be understood by persons skilled in the art that each subgraph needs only to be aware of their one “parent” container, as other “parents” in a hierarchy of subgraphs may be found by recursion. As will be appreciated, an expandShrinkDiagonally( ) could be implemented in alternative embodiments.

At step 80, the subgraph shifted at step 74 redoes the layout of its graphical elements. When redoing the layout of graphical elements of a subgraph, the specific actions required to achieve this depend on how the developer has defined the subgraphs, and these actions will be determined at development time. In an example implementation of an embodiment of the present invention, all the nodes within a subgraph are aligned to the (x,y) coordinates of the subgraph, which are the coordinates of the upper-leftmost node of the subgraph. The (x,y) coordinates are used to first orient the subgraph to its new position, and are then used to identify a reference point in adjusting the relative positions of all other graphical elements with the subgraph. In order to avoid overlapping of nodes and connections and to provide a clearer view of them when displayed, bend points may also be added to the connections at this step.

At step 82, if an internal subgraph exists, a redoing of the layout of the graphical elements in the internal subgraph is performed.

At step 84, a redoing of the layout of the graphical elements in a container subgraph, if found at step 78, is performed. In the example implementation described with reference to FIG. 2, steps 80, 82, and 84 are performed by the redoLayout( ) method, which is defined in abstract subgraph class 50 (FIG. 2) and which is implemented in classes that extend abstract subgraph class 50. Other methods that return properties on a given subgraph such as getHeight( ), getwidth( ), getLocation( ), getOutPaths( ), and getInPaths( ) may also be used by the redoLayout( ) method as required, in this example implementation.

The specific actions in finding internal and container subgraphs will depend on the subgraphs that are defined by the developer. Programming methods may be defined in each of the specific subgraph classes to find internal and container subgraphs. For example, internal subgraphs may be found in a given subgraph by searching the given subgraph for nodes that are keys to subgraphs, and by subsequently looking up those subgraphs in a hash map, where used. Similarly, container subgraphs may be found by searching outside a given subgraph for keys to subgraphs, and by subsequently looking up those subgraphs in a hash map, where used.

The framework described above with reference to FIGS. 2 and 3A to 3C that may be used by software developers to design software applications in which a constrained graph is displayed, allow multiple display views to be supported by isolating the display view implementation away from the layout control and the definition of the components of subgraphs. The display views are only addressed when they are applied to the way a specific subgraph will layout its graphical elements to correspond to a specific display view. Each specific subgraph type is defined using a separate specific subgraph class to implement their layout for a specific display view. The framework also allows software developers to define different types of additional subgraphs or to alter definitions of existing subgraph types easily, as each type of subgraph is defined using a separate class. Each specific subgraph will contain specific information on the graphical elements it contains. This information is separated from the layout manager, and from similar information on other subgraphs. The layout manager only needs to know what different subgraph types exist. Implementation details are kept internal to the respective classes.

The framework is simple because it breaks down a complex constrained graph into simple, manageable pieces (i.e. subgraphs) that can easily be manipulated and controlled. If the constrained graph becomes more complex, it will still be broken down in the same manner; there will only be more pieces. Each of these pieces will still perform their required actions, unaware of the size and complexity of the larger constrained graph.

As the framework is object-oriented, it is easy to add new subgraph classes and extend existing subgraph classes. This can speed up the development process and can aid in the future maintenance of applications developed using the framework. Understanding of the design of a software application is more easily facilitated, as the different components that may be used are defined in separate classes and interfaces.

The framework represents a general approach to tackling the problem of displaying and sequencing constrained graphs effectively. As these graphs occur in many flow applications, this framework may be applied to other applications and tools that require this layout capability in their user interfaces.

In order to facilitate a better understanding of the present invention, an example implementation of the present invention is described in detail with reference to FIGS. 4 through 8. In this example implementation, an editor has been developed for use in a public process tool. A public process tool is a business-to-business tool that defines a flow of business information between business partners. Once this flow is created by a user, the flow is implemented by each partner. The flow is made up of components such as business partner actions and business objects that can directly flow, branch, or loop between partner actions. These components can be broken down, and represented by basic flow graphical elements such as nodes, terminals and connections. An editor is provided to users for displaying and editing a constrained graph composed of nodes, terminals and connections, used to model a given public process.

The editor displays the constrained graph using the present invention. In applying the framework upon which the present invention is based, a public process is subdivided into three different types of subgraphs: a partner subgraph, a branch/join subgraph, and a loop subgraph. A partner subgraph consists of a partner action node that will have connections entering and exiting the node. A branch/join subgraph consists of a branch node and a join node, and any number of branch connections between the two. A branch/join subgraph can also have nested subgraphs contained inside of it. A loop subgraph consists of two partner action nodes and a loop connection between the two. A loop subgraph can also have nested subgraphs contained inside of it (i.e. “internal subgraphs”).

Referring to FIG. 4, an example of a graph displayed in an editor developed in accordance with an example implementation of an embodiment of the present invention is shown generally as 90. In graph 90, there are three subgraphs that are nested. There is a loop subgraph 100 that contains an internal branch/join subgraph 102. Branch/join subgraph 102 contains an internal partner subgraph 104, as illustrated. Graph 90 also contains a number of partner action nodes 106, a branch node 108, and a join node 110. Graph 90 also contains a source node 112 and sink node 114 to identify endpoints of the graph. In particular, source node 112 is also used as a reference point in performing a layout of the graphical elements of graph 90.

In this example, a user can create and modify public processes using the editor, implemented by a module of the public process tool. The editor relies on the invention to lay out the subgraphs of graph 90 for display according to a specified layout view. Other components of the public process tool are designed to handle the addition and deletion of specific components inside the public process, but the layout manager and subgraphs are designed to control the shifting of subgraphs, and the creation and altering of connections within the subgraphs.

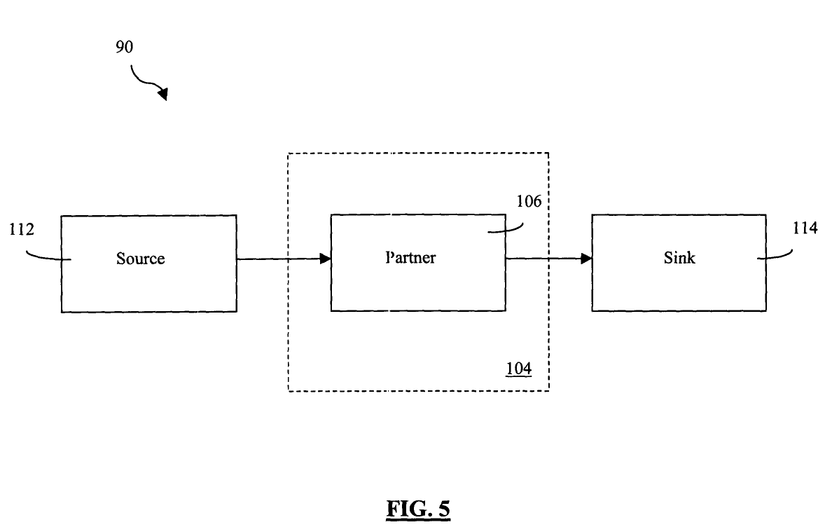

FIGS. 5 to 8 are further examples of graphs displayed in an editor developed in accordance with an example implementation of an embodiment of the present invention. These Figures illustrate different use cases, where the user interacts with the public process tool, and where changes in the display of the graphical elements of a graph occur in response to the interactions.

FIG. 5 shows a graph 90 after a user has requested the addition of a step (i.e. a partner action node 106) to the public process, by selecting the corresponding menu item [not shown] and clicking on the connection in graph 90 where the step should be placed. The tool has deleted the original connection selected by the user, and has created two new connections and a new partner node 106, placed where the original connection was located. Accordingly, any nodes to the right of the new partner node are to be shifted to the right, and any connection bend points affected by the shift are also to be shifted to the right in this example implementation.

In this example implementation, after the new node is created and connected in graph 90, a horizontal layout manager is created. The horizontal layout manager parses the entire graph 90 and creates a hash map of the subgraphs found, which in FIG. 5, is only one partner subgraph 104. The horizontal layout manager then commands partner subgraph 104 to shift itself away from the source node 112. Partner subgraph 104 then searches for any directly following subgraphs (in this implementation, directly following subgraphs would be to the right of partner subgraph 104) and commands them to shift out (i.e. to the right, in this example implementation). Any internal subgraphs within partner subgraph 104 with graphical elements that must also be shifted are commanded to shift (but partner subgraph 104 does not have an internal subgraph in this example). In FIG. 5, there are no other directly following subgraphs, so partner subgraph 104 simply commands the sink node 114 to shift out. Partner subgraph 104 then looks for a container subgraph (i.e. a parent subgraph), and if found, commands it to expand to accommodate the new node and connections (but one does not exist in this example graph 90). The horizontal layout manager commands partner subgraph 104 to redo its layout (which is simple in this case, since there are no connections in a partner subgraph 104). Partner subgraph 104 redoes its layout and then searches for any internal subgraphs and commands them to redo their layouts (but one does not exist in this example graph 90). Any container subgraphs would then redo their layouts (but one does not exist in this example, as indicated above). Accordingly, the display of graph 90 has been refreshed to accommodate the addition of the new node and connections.

Persons skilled in the art will appreciate that similar steps may be used to delete a partner node 106 from a graph 90. The user can request a partner node to be deleted by selecting the partner node 106 to be deleted, and the tool will delete the selected partner node 106 and related connections. Any nodes to the right of the deleted node, and any connection bend points affected by the deletion would be shifted to the left, in this example implementation. In this example implementation, the same steps as described above would be followed in response to the deletion request, except that directly following subgraphs, if any, are commanded to shift in (i.e. left and towards source node 112, in this example implementation), and container subgraphs are commanded to shrink instead of expand to accommodate the deleted node and connections.

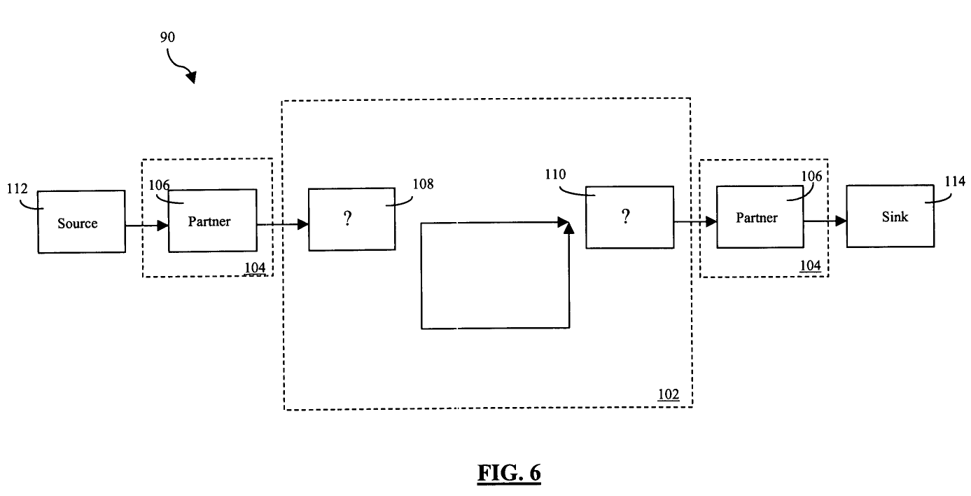

FIG. 6 shows a graph 90 after a user has requested the addition of a branch (i.e. a branch node 108 and a join node 110) to the public process, by selecting the corresponding menu item [not shown] and clicking on the connection in graph 90 where the branch should start. The tool has deleted the original connection selected by the user, and has created two new connections and a new branch node 108, which are placed where the original connection was located. Accordingly, any nodes to the right of the new branch node 108 are to be shifted to the right, and any connection bend points affected by the shift are also to be shifted to the right in this example implementation. The user has also clicked on a second connection where the branch should end. The tool has deleted the second connection selected by the user, and has created three new connections and a join node 110. Join node 110 and two connections are placed where the second connection was located, and the last connection is placed between branch node 108 and join node 110, with two bend points created at right angles to create a rectangle shape between the two nodes. Accordingly, any nodes to the right of the new join node 110 are to be shifted to the right, and any connection bend points affected by the shift are also to be shifted to the right in this example implementation. Any nodes or connections that overlap with this new addition are to be laid out again.

In this example implementation, after the new nodes are created and connected in graph 90, a horizontal layout manager is created. The horizontal layout manager parses the entire graph 90 and creates a hash map of the subgraphs found, which in FIG. 6, include two partner subgraphs 104 and one branch/join subgraph 102. The horizontal layout manager then commands branch/join subgraph 102 to shift itself away from the source node 112. Branch/join subgraph 102 then searches for any directly following subgraphs and commands them to shift out (i.e. to the right, in this example implementation). In FIG. 6, a partner subgraph 104 will be found and commanded to shift. Any internal subgraphs within branch/join subgraph 102 with graphical elements that must also be shifted are commanded to shift (but branch/join subgraph 102 does not have an internal subgraph in this example). Branch/join subgraph 102 then looks for a container subgraph (i.e. a parent subgraph), and if found, commands it to expand to accommodate the new node and connections (but one does not exist for branch/join subgraph 102 in this example graph 90). The horizontal layout manager commands branch/join subgraph 102 to redo its layout. Branch/join subgraph 102 redoes its layout, which in this case, would entail laying out its internal connections and creating bend points in the appropriate branch connection to create a rectangle shape between the branch node 108 and join node 110. The layout rules to achieve this are defined in a separate specific subgraph class that determines how these types of subgraphs are to be displayed in a horizontal view. Branch/join subgraph 102 then searches for any internal subgraphs, and commands them to redo their layouts (but one does not exist for branch/join subgraph 102 in this example graph 90). Any container subgraphs would then redo their layouts (but one does not exist for branch/join subgraph 102 in this example, as indicated above). Accordingly, the display of graph 90 has been refreshed to accommodate the addition of the new nodes and connections.

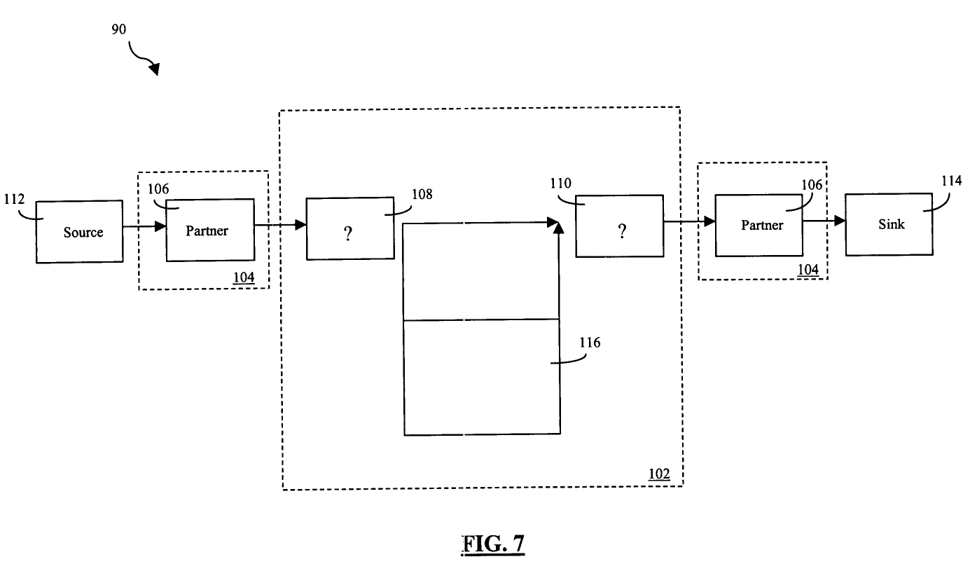

Referring to FIG. 7, further connections 116 between existing branch nodes 108 and join nodes 110 can also be created by a user, by clicking on the appropriate menu item [not shown] and a pair of branch and join nodes (108, 110), as shown in the Figure. A process similar to that described with reference to FIG. 6 may be performed, except that an extra connection in the branch/join subgraph 102 would have to be laid out, and new bend points created.

Persons skilled in the art will appreciate that similar steps may be used to delete a branch from a graph 90. The user can request a branch to be deleted by selecting a branch node 108 or a join node 110 to be deleted, and the tool will delete all the nodes and connections that make up the branch/join subgraph 102. Any nodes to the right of the deleted node, and any connection bend points affected by the deletion would be shifted to the left, in this example implementation. Any nodes or connections that can be laid out to fill in any gaps that are left after the branch is removed are repositioned accordingly. In the example implementation, the same steps as described above would be followed in response to the deletion request, except that directly following subgraphs, if any, are commanded to shift in (i.e. left and towards source node 112, in this example implementation), and container subgraphs are commanded to shrink instead of expand to accommodate the deleted nodes and connections.

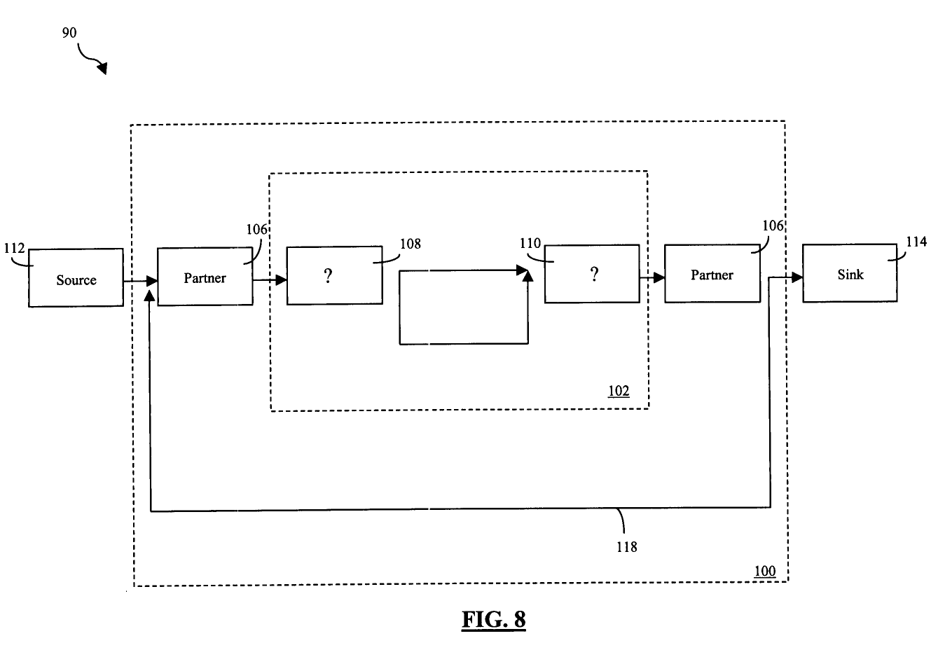

FIG. 8 shows a graph 90 after a user has requested the addition of a loop (i.e. a loop connection between two partner nodes 106) to the public process, by selecting the corresponding menu item [not shown] and clicking on a first partner node 106 where the loop is to start, and subsequently clicking on a second partner node 106 where the loop is to stop. The tool has created a new connection 118 between the new partner nodes 106 selected. Accordingly, two bend points in the new connection 118 are to be created, to create a rectangle shape between the two partner nodes 106. Any nodes or connections that overlap with this new connection 118 are to be laid out again.

In this example implementation, after the new connection is created and connected in graph 90, a horizontal layout manager is created. The horizontal layout manager parses the entire graph 90 and creates a hash map of the subgraphs found, which in FIG. 8, includes one loop subgraph 100 and one branch/join subgraph 102. In this implementation, the partner action nodes 106 are included and handled with the definition of loop subgraph 100. The horizontal layout manager then commands loop subgraph 100 to shift itself away from the source node 112. Loop subgraph 100 then searches for any directly following subgraphs and commands them to shift out (i.e. to the right, in this example implementation). In FIG. 8, there are no directly following subgraphs, but there is an internal branch/join subgraph 102, which must also be commanded to shift out. Loop subgraph 100 then looks for a container subgraph (i.e. a parent subgraph), to command it to expand to accommodate the new connections and internal changes to the loop subgraph 100 (but a container subgraph that contains loop subgraph 100 does not exist in this example graph 90). The horizontal layout manager then commands loop subgraph 100 to redo its layout. Loop subgraph 100 redoes its layout, by laying out the new connection 118, creating bend points in the new connection 118 to create the rectangle shape between the two partner nodes 106 of loop subgraph 100, and commands its internal subgraph, branch/join subgraph 102 to also redo its layout. Loop subgraph 100 then commands its container subgraph to redo its layout (but one does not exist for loop subgraph 100 in this example graph 90). Accordingly, the display of graph 90 has been refreshed to accommodate the addition of the new node and connections.

Persons skilled in the art will appreciate that similar steps may be used to delete a loop from a graph 90. The user can request a loop to be deleted by selecting the loop connection 118 to be deleted, which the tool will delete. Any nodes or connections that can be laid out to fill in any gaps left after the loop is removed are repositioned accordingly.

In preferred embodiments of the invention, a layout manager is adapted to identify all subgraphs in a constrained graph before shifting a selected graph. However, in variant embodiments of the invention, the layout manager may be adapted to find a subset of subgraphs in the constrained graph under some scenarios where performance may be optimized by doing so. For example, in some implementations, a layout manager may be adapted to ignore complete subgraphs to the left of a newly-inserted subgraph in a horizontal (left-to-right) view as they are not affected by the insertion of the new subgraph.

The present invention has been described with regard to specific embodiments. However, it will be obvious to persons skilled in the art that a number of variants and modifications can be made without departing from the scope of the invention defined in the claims appended hereto.

1. A software system for constrained graphs, the system implemented in accordance with an object-oriented design framework, wherein said graph is constructed using a plurality of graphical elements, the system comprising:
a plurality of subgraph classes, wherein an instance of each of said subgraph classes comprises a predefined grouping of one or more of said graphical elements representative of a subgraph type; and
each of said plurality of subgraph classes adapted to:
reposition the graphical elements of a subgraph within said graph, said subgraph represented by an instance of one of said plurality of subgraph classes; and
initiate a repositioning of the graphical elements of subgraphs affected by said repositioning of the graphical elements of the subgraph represented by said instance of said one of said plurality of subgraph classes.

2. The software system of claim 1, wherein each of said plurality of subgraph classes is further adapted to:
display the graphical elements of a subgraph represented by said instance of said one of said plurality of subgraph classes to a user in a specified layout format.

3. The software system of claim 2, wherein said specified layout format comprises a layout selected from the following group: a horizontal layout and a vertical layout.

4. The software system of claim 2, wherein said specified layout comprises a directional layout.

5. The software system of claim 1, further comprising a first subgraph class wherein said first subgraph class is extended to define said plurality of subgraph classes.

6. The software system of claim 5, wherein said first subgraph class comprises an abstract class.

7. The software system of claim 1, further comprising:
a layout manager adapted to:
initiate the repositioning and display of the graphical elements of a plurality of subgraphs in said graph by commanding the repositioning and display of the graphical elements of a selected subgraph in said graph.

8. The software system of claim 7 wherein said layout manager is further adapted to:
identify a plurality of subgraphs in said graph;
receive an identifier of an input subgraph in said graph;
determine from said identifier a selected subgraph to be shifted; and
command said selected subgraph to reposition and display the graphical elements.

9. The software system of claim 8 further comprising
a first layout manager class which can be extended to define one or more second layout manager classes; and
wherein said layout manager comprises an instance of a second layout manager class.

10. The software system of claim 8, wherein the selected subgraph determined from said identifier comprises said input subgraph.

11. The software system of claim 9, wherein said instance of a second layout manager class is created when one or more graphical elements are added to or deleted from said graph.

12. The software system of claim 11, further comprising a module for obtaining input from a user, wherein a request to add or delete graphical elements from said graph is generated from said input.

13. The software system of claim 8, wherein data associated with subgraphs identified by an instance of said second layout manager class is stored in a map, and wherein said map is used by instances of said second subgraph classes in determining affected subgraphs.

14. The software system of claim 13, wherein said map comprises a hash map.

15. The software system of claim 1, wherein said repositioning of the graphical elements of said specific subgraph requires that said graphical elements be shifted either horizontally or vertically in said graph.

16. The software system of claim 2, wherein said specified layout comprises a directional layout.

17. The software system of claim 1, wherein a subgraph comprises a further subgraph.

18. The software system of claim 1, wherein each of said plurality of second subgraph classes is further adapted to determine data properties for instances thereof, the data properties selected from the following group: height of subgraph, width of subgraph, location of subgraph on a display device, connections going into a subgraph, and connections going out of a subgraph.

19. A software system for use in the design of software applications in which a constrained graph is displayed, the system implemented in accordance with an object-oriented design framework, wherein said graph is constructed using a plurality of graphical elements, the system comprising:
a first subgraph class, wherein said first subgraph class can be extended to define a plurality of second subgraph classes, wherein an instance of each of said second subgraph classes represents a subgraph of a specific subgraph type, wherein each subgraph of a specific subgraph type is composed of a predefined grouping of one or more of said graphical elements, and wherein each of said plurality of second subgraph classes implements one or more first methods for
repositioning the graphical elements of a subgraph represented by an instance thereof within said graph and determining affected subgraphs,
displaying the graphical elements of a subgraph represented by an instance thereof to said user in a specified layout format, and
commanding a repositioning and display of the graphical elements of said affected subgraphs.

20. The software system of claim 19, further comprising a first layout manager class, wherein said first layout manager class can be extended to define one or more second layout manager classes, wherein an instance of each of said second layout manager classes represents a layout manager, wherein each of said second layout manager classes implements one or more second methods for
identifying a plurality of subgraphs in said graph,
receiving an identifier of an input subgraph in said graph,
determining from said identifier a selected subgraph to be shifted, and
commanding a repositioning and display of the graphical elements of said selected subgraph by calling the one or more first methods implemented by the second subgraph class of which said selected subgraph is an instance;
such that when an instance of a second layout manager class is created, said one or more second methods are executed, whereby the layout manager represented by said instance identifies a plurality of subgraphs in said graph and initiates the repositioning and display of the graphical elements of a plurality of subgraphs in said graph by commanding the repositioning and display of the graphical elements of a selected subgraph in said graph.

21. The system as claimed in claim 19, wherein said first subgraph class is an abstract class.

22. The system as claimed in claim 20, wherein the selected subgraph determined from said identifier is said input subgraph.

23. The system as claimed in claim 19, wherein said instance of a second layout manager class is created when one or more graphical elements are added to or deleted from said graph.

24. The system as claimed in claim 23, further comprising a module for obtaining input from a user, wherein a request to add or delete graphical elements from said graph is generated from said input.

25. The system as claimed in claim 19, wherein data associated with subgraphs identified by an instance of said second layout manager class is stored in a map, and wherein said map is used by instances of said second subgraph classes in determining affected subgraphs.

26. A computer readable media storing data and instructions, said data and instructions when executed by a computing device adapt said computing device to:
organize a plurality of subgraph classes, wherein an instance of each of said subgraph classes comprises a predefined grouping of one or more of said graphical elements representative of a subgraph type; and
each of said plurality of subgraph classes adapted to:
reposition the graphical elements of a subgraph within said graph, said subgraph represented by an instance of one of said plurality of subgraph classes; and
initiate a repositioning of the graphical elements of subgraphs affected by said repositioning of the graphical elements of the subgraph represented by said instance of said one of said plurality of subgraph classes.

27. The computer readable media of claim 26, wherein each of said plurality of subgraph classes is further adapted to:
display the graphical elements of a subgraph represented by said instance of said one of said plurality of subgraph classes to a user in a specified layout format.

28. The computer readable media of claim 26, wherein said specified layout format comprises a layout selected from the following group: a horizontal layout and a vertical layout.

29. The computer readable media of claim 26, wherein said specified layout comprises a directional layout.

30. The computer readable media of claim 26, further adapting said computer device to organize a first subgraph class wherein said first subgraph class is extended to define said plurality of subgraph classes.

31. The computer readable media of claim 30, wherein said first subgraph class comprises an abstract class.

32. The computer readable media of claim 26, further adapting said computer device to:
organize a layout manager adapted to:
initiate the repositioning and display of the graphical elements of a plurality of subgraphs in said graph by commanding the repositioning and display of the graphical elements of a selected subgraph in said graph.

33. The computer readable media of claim 32 wherein said layout manager is further adapted to:
identify a plurality of subgraphs in said graph;
receive an identifier of an input subgraph in said graph;
determine from said identifier a selected subgraph to be shifted; and
command said selected subgraph to reposition and display the graphical elements.

34. The computer readable media of claim 8 further adapting said computer device to:
organize a first layout manager class which can be extended to define one or more second layout manager classes; and
wherein said layout manager comprises an instance of a second layout manager class.

35. The computer readable media of claim 33, wherein the selected subgraph determined from said identifier comprises said input subgraph.

36. The computer readable media of claim 32, wherein said instance of a second layout manager class is created when one or more graphical elements are added to or deleted from said graph.

37. The computer readable media of claim 36, further adapting said computer device to organize a module for obtaining input from a user, wherein a request to add or delete graphical elements from said graph is generated from said input.

38. The computer readable media of claim 33, wherein data associated with subgraphs identified by an instance of said second layout manager class is stored in a map, and wherein said map is used by instances of said second subgraph classes in determining affected subgraphs.

39. The computer readable media of claim 32, wherein said map comprises a hash map.

40. The computer readable media of claim 26, wherein said repositioning of the graphical elements of said specific subgraph requires that said graphical elements be shifted either horizontally or vertically in said graph.

41. The computer readable media of claim 26, wherein said specified layout comprises a directional layout.

42. The computer readable media claim 26, wherein a subgraph comprises a further subgraph.

43. A layout manager defined by a layout manager interface, said layout manager interface provided by a software system for use in the design of software applications in which a constrained graph is displayed to a user, the system implemented in accordance with an object-oriented design framework, wherein said graph is constructed using a plurality of graphical elements, the system comprising:
a first subgraph class, wherein said first subgraph class can be extended to define a plurality of second subgraph classes, wherein an instance of each of said second subgraph classes represents a subgraph of a specific subgraph type, wherein each subgraph of a specific subgraph type is composed of a predefined grouping of one or more of said graphical elements, and wherein each of said plurality of second subgraph classes implements one or more first methods for
repositioning the graphical elements of a subgraph represented by an instance thereof within said graph and determining affected subgraphs,
displaying the graphical elements of a subgraph represented by an instance thereof to said user in a specified layout format, and
commanding a repositioning and display of the graphical elements of said affected subgraphs; and
a first layout manager class interface, wherein said first layout manager class can be extended to define one or more second layout manager classes, wherein an instance of each of said second layout manager classes represents a layout manager, wherein each of said second layout manager classes implements one or more second methods for
identifying a plurality of subgraphs in said graph,
receiving an identifier of an input subgraph in said graph,
determining from said identifier a selected subgraph to be shifted, and
commanding a repositioning and display of the graphical elements of said selected subgraph by calling the one or more first methods implemented by the second subgraph class of which said selected subgraph is an instance;
such that when an instance of a second layout manager class is created, said one or more second methods are executed, whereby layout manager represented by that instance identifies a plurality of subgraphs in said graph and initiates the repositioning and display of the graphical elements of a plurality of subgraphs in said graph by commanding the repositioning and display of the graphical elements of a selected subgraph in said graph.

44. A method of displaying a constrained graph, said graph constructed using a plurality of graphical elements, wherein a first subgraph class is defined that can be extended to define a plurality of second subgraph classes, wherein an instance of each of said second subgraph classes represents a subgraph of a specific subgraph type, wherein each subgraph of a specific subgraph type is composed of a predefined grouping of one or more of said graphical elements, and wherein each of said plurality of second subgraph classes implements one or more first methods for repositioning the graphical elements of a subgraph represented by an instance thereof within said graph and determining affected subgraphs, displaying the graphical elements of a subgraph represented by an instance thereof to said user in a specified layout format, and commanding a repositioning and display of the graphical elements of said affected subgraphs, said method comprising:
identifying a plurality of subgraphs in said graph;
receiving an identifier of an input subgraph in said graph;
determining from said identifier a selected subgraph to be shifted; and
commanding a repositioning and display of the graphical elements of said selected subgraph by calling the one or more first methods implemented by the second subgraph class of which said selected subgraph is an instance;
whereby a plurality of subgraphs in said graph are identified, and the repositioning and display of the graphical elements of a plurality of subgraphs in said graph is initiated by commanding the repositioning and display of the graphical elements of a selected subgraph in said graph.

45. The method as claimed in claim 44, wherein said first subgraph class is an abstract class.

46. The method as claimed in claim 44, wherein the selected subgraph determined from said identifier is said input subgraph.

47. The method as claimed in claim 44, wherein said steps of said method are performed when one or more user-specified graphical elements are added to or deleted from said graph.

48. The method as claimed in claim 44, wherein data associated with subgraphs identified is stored in a map, and wherein said map is used by instances of said second subgraph classes in determining affected subgraphs.

49. A method of displaying a constrained graph, said graph comprising a plurality of graphical elements and a plurality of subgraphs, wherein each of said plurality of subgraphs comprises a grouping of one or more of said graphical elements, said method comprising:
determining from an identifier of an input subgraph in said graph, a selected subgraph to be repositioned; and
repositioning the graphical elements of said selected subgraph.

50. A method of displaying a constrained graph, said graph comprising a plurality of graphical elements and a plurality of subgraphs, wherein each of said plurality of subgraphs comprises a grouping of one or more of said graphical elements, said method comprising:
repositioning the graphical elements of a subgraph within said graph; and
initiate a repositioning of the graphical elements of subgraphs affected by said repositioning of the graphical elements of said subgraph.

51. The method of claim 50, wherein each of said plurality of subgraphs is adapted to display the graphical elements of a subgraph in a specified layout format.

52. The method of claim 50, further comprising:
initiating the repositioning and display of the graphical elements of a plurality of subgraphs in said graph by commanding the repositioning and display of the graphical elements of a selected subgraph in said graph.

53. The method of claim 52 further comprising:
identifying a plurality of subgraphs in said graph;
receiving an identifier of an input subgraph in said graph;
determining from said identifier a selected subgraph to be shifted; and
commanding said selected subgraph to reposition and display the graphical elements.
